(19) United States
(12) Patent Application Publication
(10) Pub. No.: US 2008/0240521 A1
(43) Pub. Date: Oct. 2, 2008

(54) COLLATING SYSTEM AND METHOD AND PROGRAM

(76) Inventor: JUN MIYAZAKI, Tokyo (JP)

Correspondence Address: NEC CORPORATION OF AMERICA, 6535 N. STATE HWY 161, IRVING, TX, 75039, US

(21) Appl. No.: 12/056,840

(22) Filed: Mar. 27, 2008

(30) Foreign Application Priority Data
Mar. 27, 2007 (JP) 2007-080536

(51) Int. Cl. G06K 9/00

(52) U.S. Cl. 382/124

(57) ABSTRACT

A collating system includes a storage section configured to store a reference fingers and palm print data of a reference fingerprint data and a reference palm print data, and a collating unit configured to collate the target fingers and palm print data and the reference fingers and palm print data. The reference fingers and palm print data have a same data configuration as that of a target fingers and palm print data.

This patent application is based on Japanese Patent Application No. 2007-080536. The disclosure thereof is incorporated herein by reference.

### TECHNICAL FIELD

The present invention relates to a collating system, and more particularly relates to a collating system that can collate a fingerprint and a palm print.

### BACKGROUND ART

Conventionally, in order to authenticate a person, a fingerprint and a palm print are used. In recent years, the fingerprint and the palm print have been collated by a computer by using feature amounts of the fingers and palm prints. One example of the collating system of the fingerprint and the palm print is disclosed in Japanese Patent Application Publication (JP-P2002-14934A).

However, in the conventional finger palm print collating system, data formats are different between a fingerprint data and a palm print data. Thus, both of the data could not be stored and used in a shared memory area. Also, since a palm print collation program requires a large capacity of a memory area, the shared memory area is used as a work area. Thus, a host unit is required to switch the collation programs on the basis of a collation type and a print kind data of fingerprint/palm print collation. Therefore, the parallel execution between the fingerprint collation and the palm print collation is impossible.

FIG. 1 shows the configuration of the collating system in a related art. In the example shown in FIG. 8, at first, a plurality of search fingerprint data 201 to 20n are stored in a shared memory area 200 that is commonly accessible from fingerprint collation programs 310, 320 and 330, which are loaded in a program memory area 300. Each fingerprint collation program reads out the search fingerprint data specified based on the collation command from the shared memory area 200, and collates the read-out search fingerprint data with a collation fingerprint data. Also, in the program memory area 300, memory addresses 311, 312, 321, 322, 331, and 332 are fixedly assigned to the fingerprint collation programs 310 and 320, and the palm print program 330. Each program carries out memory management in a memory address range assigned to the program. For this reason, when a plurality of different palm print programs are contained, an area (for example, an area 332) used as the fixedly assigned work area has a great capacity. Thus, the memory use limit needs to be set on the basis of the program. Also, each time the new fingerprint program is installed, the memory map of hardware need to be changed.

### SUMMARY

It is therefore an object of the present invention to provide a collating system, in which a collating processes for a fingerprint and a palm print can be executed in a higher speeds, and also the system configuration can be simplified.

In a first exemplary embodiment of the present invention, a collating system includes a storage section configured to store a reference fingers and palm print data of a reference fingerprint data and a reference palm print data, and a collating unit configured to collate the search fingers and palm print data and the reference fingers and palm print data. The reference fingers and palm print data have a same data configuration as that of a search fingers and palm print data.

In a second exemplary embodiment of the present invention, a collating method includes reading out a reference fingers and palm print data containing a fingerprint data and a palm print data which have a same data configuration; and collating a search fingers and palm print data and the reference fingers and palm print data.

In a third exemplary embodiment of the present invention, a computer-readable software medium in which codes of a program are written to realize a collating method is provided. The collating method includes reading out a reference fingers and palm print data containing a fingerprint data and a palm print data which have a same data configuration; and collating a search fingers and palm print data and the reference fingers and palm print data.

### BRIEF DESCRIPTION OF DRAWINGS

The above and other objects, advantages and features of the present invention will be more apparent from the following description of certain exemplary embodiments taken in conjunction with the accompanying drawings, in which:

FIG. 1 is a block diagram showing an entire configuration of a collating system;

FIG. 2 is a functional block diagram showing a configuration of a collating unit;

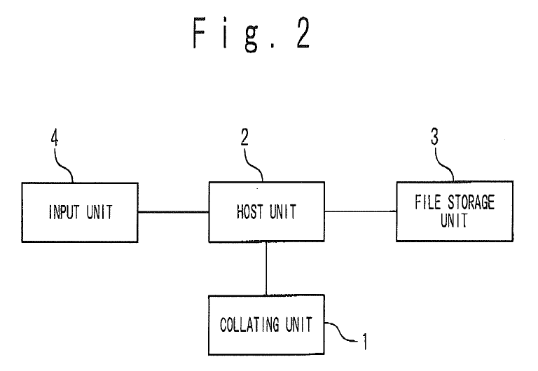

FIG. 3 is a block diagram showing a configuration of a memory in the collating unit;

FIG. 4 is an explanation view showing a site of a palm print;

FIG. 5 is a diagram showing a data configuration example of a fingerprint data and a palm print data;

FIGS. 6A and 6B are diagrams showing a data configuration example of a fingerprint data and a palm print data;

FIG. 7 is a sequence view showing an operation of a collating system; and

FIG. 8 is a functional block diagram showing a configuration of a collating unit in a conventional example.

### EXEMPLARY EMBODIMENTS

Hereinafter, a collating system according to exemplary embodiments of the present invention will be described in detail with reference to the attached drawings. The collating system performs collation of a fingerprint and a palm print in accordance with an instruction from a host unit.

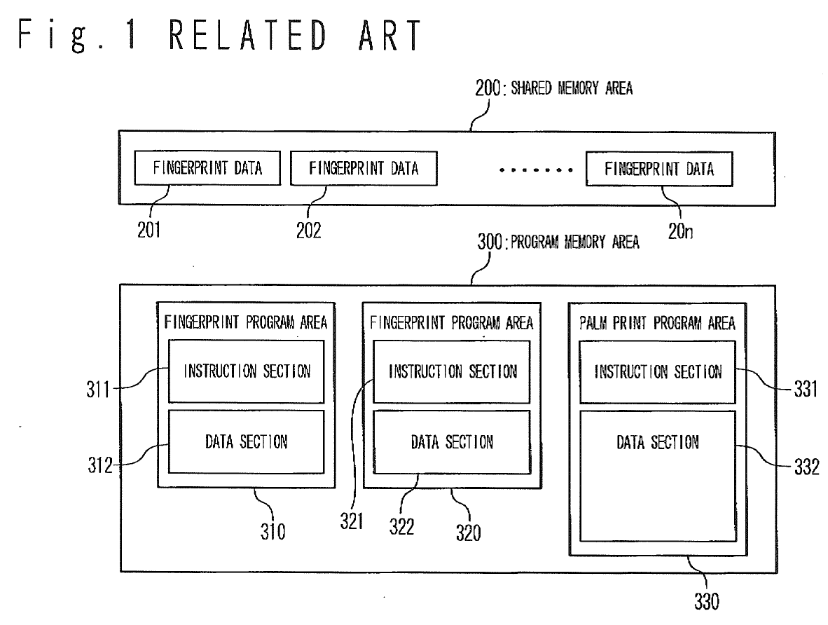

FIG. 1 is a block diagram showing a configuration of the collating system according to a first exemplary embodiment of the present invention. The collating system includes a collating unit 1, a host unit 2, a file storage unit 3 and an input unit 4, as shown in FIG. 1. The collating unit 1 and the host unit 2 are connected through a cable and network. In response to a collation command from the host unit 2, the collating unit 1 performs a collating process. The input unit 4 is, for example, a scanner unit. The input unit 4 is used to input a fingerprint data and a palm print data (fingers and palm print data) as a target data to the host unit 2. The target data may be a data to be collated when the fingers and palm data are directly pushed against the input unit 4, or may be a data of the fingers and palm left on an article.

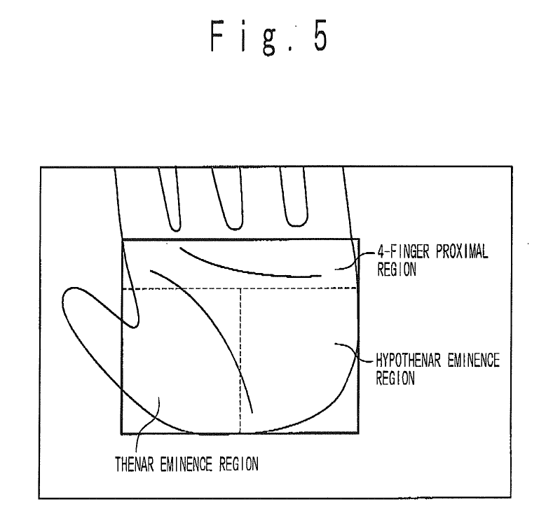

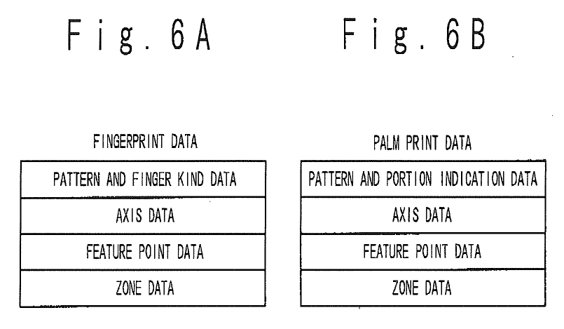

A fingerprint data and a palm print data as the target data or a reference data are configured to have a same data structure. In short, each of the fingerprint data and the palm print data is defined in a common data format. FIGS. 6A and 6B show examples of the fingerprint data and the palm print data. As shown in FIGS. 6A and 6B, each data has the data structure of a pattern & finger kind (portion indication) data, an axis data, a feature point data and a zone data. In a pattern & finger kind (portion indication) data area are stored a fingerprint data or a palm print data as pattern data; a finger kind number indicating a finger corresponding to the fingerprint data; or a data indicating a portion of a palm corresponding to the palm print data and a data indicating whether or not all portions of the palm are contained in the palm print data. In an axis data area is stored a central coordinate axis data serving as an origin point coordinate when the collation is performed. In a feature point data area is stored coordinate data of the feature points of the fingerprint or palm print for the number of feature points, and the number of feature points. In a zone data area is stored the number of blocks of image of the fingerprint or palm print, and a zone data indicating whether the clearness or unclearness of the image in each block. It should be noted that FIG. 5 shows one example of the palm print data. The fingers and palm print data at least includes a portion data to specify a portion of the fingers and palm print and a feature value data of the fingers and palm print. The above data structure of the fingers and palm print is one example, and a different data structure may be used.

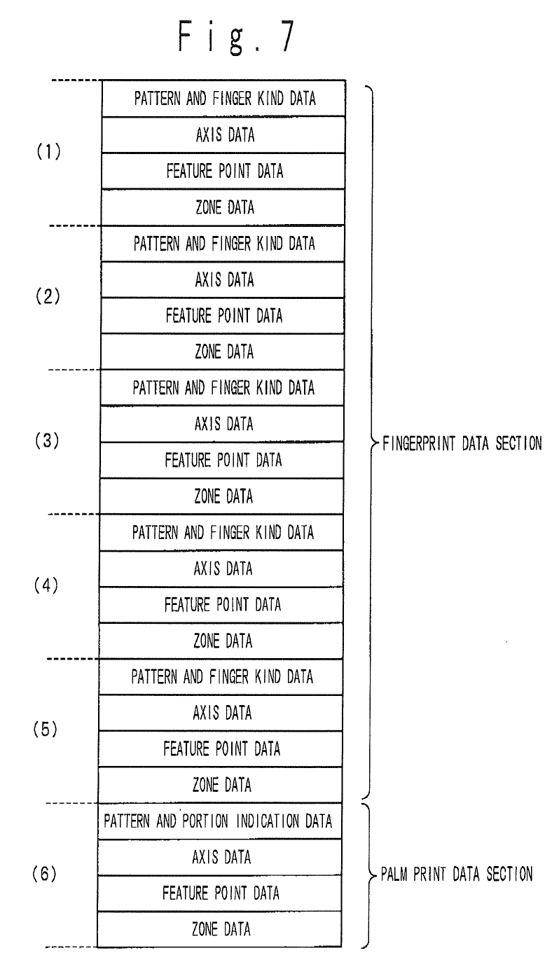

When the fingerprint data corresponding to five fingers and the palm print data corresponding to one portion are inputted from one collation target person, fingerprint data (1) to (5) corresponding to the five fingers and a palm print data (6) corresponding to the one portion are manipulated as one target data, as shown in FIG. 7. It should be noted that reference data composed of the fingerprint data and palm print data are transferred to the collating unit 1 from the host unit 2 together with a collation command, and transiently stored in the collating unit 1, as described later.

Also, a target data of fingerprint data and palm print data for pre-registered targets are stored in advance in the file storage unit 3. In short, the storage data are registered in the file storage unit 3 as a database having the target finger and palm print data to be collated with the reference data. The target fingerprint data and target palm print data as the target data also have the same data structure as the fingerprint data and palm print data of the reference data. For example, these data are configured to have the data structure as shown in FIGS. 6A, 6B and 7. It should be noted that these target data are transferred from the host unit 2 to the collating unit 1, as described later.

Also, the host unit 2 receives the target fingers and palm print data as the target data inputted from the input unit 4 and transfers the data to the collating unit 1. Also, the host unit 2 reads out the target fingers and palm print data as the target data stored in advance in the file storage unit 3 and transfers the target data to the collating unit 1 and then executes the collation command. At this time, the collation command is assumed to include a print kind data indicating one of collation of a fingerprint, collation of a palm print, and collation of both; a collation type data indicating a pushed print collation or a left print collation; a number of a target data as a collation target; and a finger kind (portion) number of the collation target. It should be noted that it is assumed that the plurality of finger kind numbers and portion numbers can be specified. Also, the host unit 2 receives a collation result notified from the collating unit 1 and outputs it from the output unit such as a display unit.

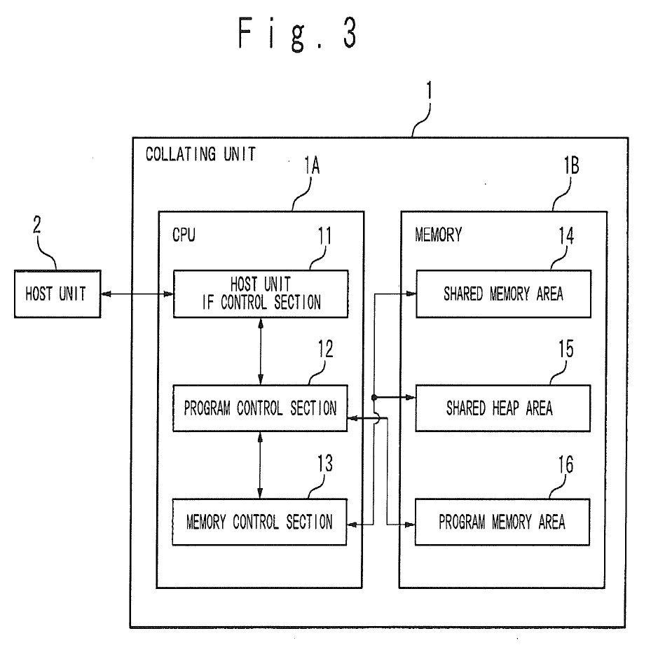

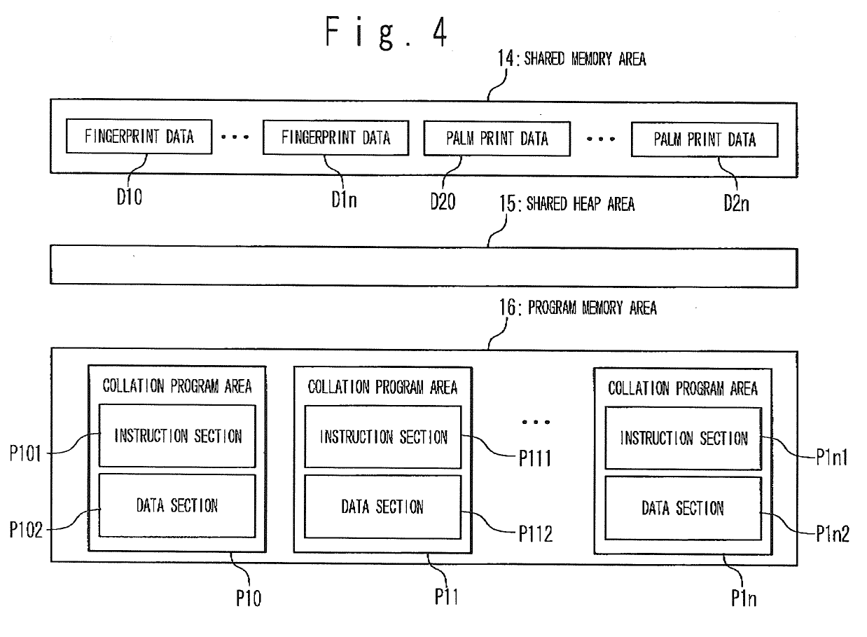

Next, the configuration of the collating unit 1 will be described below with reference to FIGS. 3 and 4. As shown in FIG. 3, the collating unit 1 is a computer that contains a CPU 1A serving as a processing unit and a memory 1B serving as a storage device. The CPU 1A executes a predetermined program and realizes a host unit IF control section 11, a program control section 12 and a memory control section 13. Moreover, a shared memory area 14, a shared heap area 15 and a program memory area 16 are formed in the memory 1B.

At first, the host unit IF control section 11 executes a process of transmitting and receiving data to and from the host unit 2. Also, the program control section 12 has a function of controlling the operation of collation programs. Specifically, as shown in FIG. 4, the program control section 12 loads collation programs P10, P11 and P1n into the program memory area 16 formed in the memory 1B. At this time, the collation program areas P10, P11 and P1n have command sections P101, P111 and P1n1 in which command sets of the collation programs are held, and program-usable data sections P102, P112 and P1n2. These data section P102, P112 and P1n2 are fixedly assigned in advance as areas having a same size (capacity).

Also, the program control section 12 transfers the target fingers and palm print data as the target data transferred from the host unit 2, to the memory control section 13, and transfers the reference fingers and palm print data and the collation command to the collation program areas P10, P11 and P1n. Consequently, the collating process is executed in accordance with the collation program loaded in the program memory area 16. At this time, each collation program assigns a part of the shared heap area 15 as a work area in which the collating process is executed. Then, each collation program executes the collating process in the data section P10, P11 and P1n that are fixedly assigned when the programs are loaded, and the work areas assigned into the shared heap area 15. It should be noted that the work area is assigned to the shared heap area 15 for each collation program. Therefore, as described later, the collating processes for the plurality of target fingers and palm print data can be executed continuously or in parallel.

Also, the memory control section 13 executes a memory management and a control in the shared memory area 14 and the shared heap area 15. Specifically, as shown in FIG. 4, fingerprint data D10 to D1n and the palm print data D20 to D2n are the target data transferred from the host unit 2 and are stored in the shared memory area 14, as mentioned above. At this time, the fingerprint data and the palm print data are configured in a same data format as mentioned above. Thus, both of the data can be stored and used in the shared memory area 14. In this way, the shared memory area 14 functions as a collation target storing section, similarly to the file storage unit 3, because the fingers and palm print data serving as the target data is temporally stored. Also, the shared heap area 15 have memory areas respectively assigned as the work areas for the respective collating processes on the basis of a memory assignment request provided when the collation program is executed by the program control section 12.

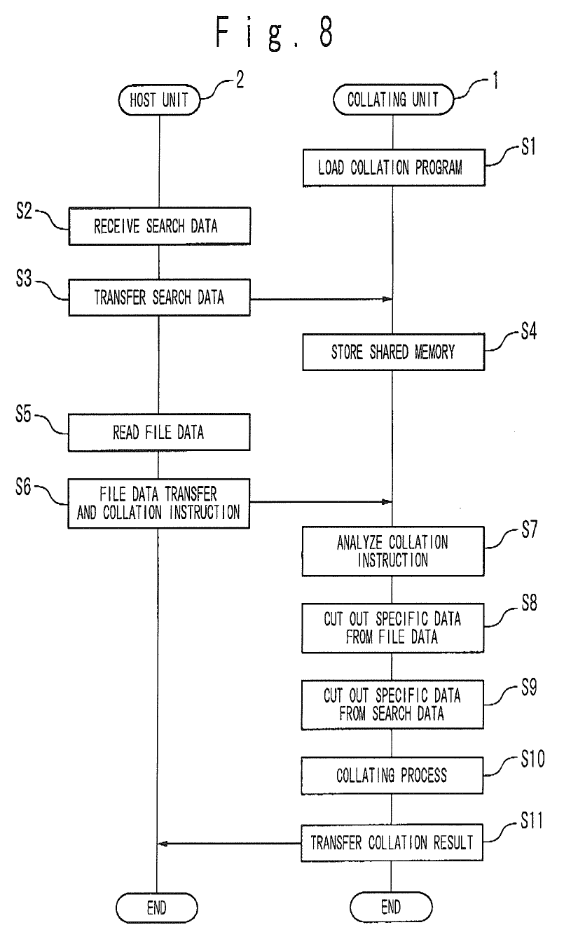

Next, the operation of the collating system having the foregoing configurations will be described below with reference to the sequence diagram shown in FIG. 8. At first, inside the collating unit 1, the program control section 12 loads the collation program to the program memory area 16 (Step S1). At this time, as shown in FIG. 4, each collation program area P10, P11 or P1n is in a situation that each command section P101, P111 or P1n1 and each data section P102, P112 or P1n2 are fixedly memory-mapped. It should be noted that the collation program may be loaded after the collation command is received from the host unit 2, as described later.

When receiving the target fingerprint data and the palm print data serving as the target data (Step S2), the host unit 2 transfers the target data to the collating unit 1 (Step S3). The collating unit 1 receives the target data from the collating unit 1 by the host unit IF control section 11 and transfers the target data to the program control section 12 in the collating unit 1. The program control section 12 stores the target data through the memory control section 13 in the shared memory area 14 (Step S4).

Subsequently, the host unit 2 reads out the pre-registered reference finger and palm print data as the reference data from the file storage unit 3 (Step S5) and transfers the reference data to the collating unit 1 and executes the collation command (Step S6). At this time, the collation command is assumed to include the print kind data indicating the fingerprint collation or palm print collation or both the collations, the collation type data indicating the print pushing collation or left print collation, the target data number, and the finger kind number (portion number) of the target. It is assumed that the plurality of finger kind numbers and site numbers can be specified.

After that, the program control section 12 in the collating unit 1 receives the collation command and analyzes the collation command (Step S7), and determines the fingerprint collation or the palm print collation from the print kind data of the collation command and cuts away the corresponding reference fingerprint data (in case that the reference data contains a plurality of fingerprint data) from the reference data based on the finger kind number (portion number) (Step S8). Also, the program control section 12 reads the corresponding target fingerprint data from the shared memory area 14 through the memory control section 13 on the basis of a target data number, and cuts away the corresponding target fingerprint data on the basis of the finger kind number (there may be a plurality of specifications) (Step S9).

Subsequently, the program control section 12 transfers the reference fingerprint data and the target fingerprint data to the corresponding collation program P10 (in this example, the collation type is the left print collation) on the basis of the specific collation type (the left print collation or the print pushed collation). It should be noted that as mentioned above, the fingerprint program for the left print collation is loaded in the collation program area P10, and the program for the print pushed collation is loaded in the collation program area P11. However, the memory area as the work area of each collation program is assigned to the shared heap area 15.

In the collation program area P10, P11 or P1n, the collating process is executed between the reference fingerprint data and the target fingerprint data, which are transferred from the program control section 12 (Step S10). For example, the collation is performed on the basis of whether or not the feature values of the respective data are coincident. After that, the collation result is returned to the program control section 12.

Subsequently, if a plurality of specific finger numbers are specified, the program control section 12 successively cuts the target fingerprint data away from the target data, and cuts the specific number of reference fingerprint data away from the reference data, and then collates the pairs of the target fingerprint data and the reference fingerprint data in the collation program area P10, P11 or P1n, in correspondence to the number of the specification data. If a plurality of data are specified, the program control section 12 merges the collation results in the collation program area P10, p11 or P1n, and transmits the merged collation result through the host unit IF control section 11 to the host unit 2 (Step S11).

Similarly, in case of the palm print collation, the palm print collation is determined from the collation kind data included in the collation command, and the reference palm print data is cut away from the reference data (if the reference data includes the reference palm print data). Also, the target data from the specific target data number is read through the memory control section 13 from the shared memory area 14, and the target palm print data is cut away (if the target data includes the target palm print data). The program control section 12 transfers the reference palm print data and the target palm print data, which are cut out to the collation program, on the basis of the specific print type (the print pushed collation or the left print collation). In the collation program area, the target palm print data and the reference palm print data, which are transferred from the program control section 12, are collated with each other, and the collation result is returned to the program control section 12. The program control section 12 transmits the collation result, which is returned in the collation program area, to the host unit 2 through the host unit IF control section 11. If both of the fingerprint collation and the palm print collation are specified in the collation command, the results of the fingerprint collation (corresponding to the five fingers in a maximum) and the palm print collation are merged and returned to the host unit 2.

According to the present invention, since the data format is common between the fingerprint data and the palm print data, both the data can be stored and used in the shared memory area. Also, it is possible to execute the collating process based on the collation program suitable for the property in accordance with the print kind and the collation type. Consequently, the collating process executed by the host unit in units of jobs need not to be switched. Also, since the common data format is used, a database in the host unit need not to be divided on the basis of the print kind, and the resource management is easy. Also, since the fingerprint and palm print data can be transferred one time, the overhead reduction in the number of times of the data transfer between the host unit and the collating unit can be attained. The fingerprint and palm print data can be made into the database at the collective block. Thus, the database management can be made simple. Also, adding the fingerprint and palm print data to the target data can improve a collation specification rate.

Moreover, since this has a function of executing the memory assignment in response to a memory assignment request from the fingerprint and palm print programs, the memory maps serving as the bases of the command and data areas between the respective fingerprint and palm print programs are assumed to be equal in size, and the memory area used as the work area uses the area of the shared heap area, and the re-utilization of the memory area is made effective, which can support the collation program without any change of the memory map of the hardware, when the new palm print program is installed. In short, with the fixed memory mapping of the minimum necessary memory area, it is possible to remove the useless memory source assignment caused by the memory area of a non-used program. Then, in the work memory area used in the collating process, the memory assignment is not executed internally and fixedly, and the memory reservation is executed from the shared heap area, and it is used. Hence, the memory can be effectively used.

The present invention can be used for the police and certification authorities to collate the fingerprint and the palm print, and has the industrial usability.

The present invention has the foregoing configurations and functions. Thus, even when the collating process for any of the fingerprint and the palm print is executed, the data structures are same. Thus, the collating process for the fingerprint or palm print needs not to be distinctively executed. In short, the collating process can be executed without switching the collation program, irrespectively of whether the collation target is the fingerprint or the palm print. Hence, it is possible to simplify the system configuration and attain the higher speed of the collating process. Also, the fingerprint data and the palm print data, which are targeted for the collation, can be managed without any distinction. Hence, this has the good effect that the data can be easily managed, which was impossible in the conventional technique.

While the present invention has been particularly shown and described with reference to the exemplary embodiments thereof, the present invention is not limited to these exemplary embodiments. It will be understood by those of ordinary skill in the art that various changes in form and details may be made therein without departing from the spirit and scope of the present invention as defined by the claims.

What is claimed is:

1. A collating system comprising:
a storage section configured to store a target fingers and palm print data of a target fingerprint data and a target palm print data, said target fingers and palm print data having a same data structure as that of a reference fingers and palm print data; and
a collating unit configured to read out said target fingers and palm print data from said storage section and to collate said target fingers and palm print data and said reference fingers and palm print data.

2. The collating system according to claim 1, wherein said fingers and palm print data comprises a portion indication data indicating a portion of a fingers and palm print and a feature value data of said fingers and palm print data.

3. The collating system according to claim 2, wherein said collating section reads a pair of said target fingers and palm print data and said reference fingers and palm print data from said storage section based on said portion indication data, and carries out a collating process of said target fingers and palm print data and said reference fingers and palm print data based on said feature value data.

4. The collating system according to claim 3, wherein said collating section carries out said collating processes of the pairs continuously or in parallel.

5. The collating system according to claim 4, wherein said collating section comprises a shared memory area in which a part of said shared memory area is assigned as a work area for each of said collating processes.

6. The collating system according to claim 5, wherein said collating section comprises fixed memory areas having a same capacity assigned to collation programs for said collating processes in advance.

7. A collating method comprising:
providing a pair of a target fingers and palm print data and a reference fingers and palm print data, which have a same data structure, and each of which contains a fingerprint data and a palm print data; and
collating said target fingers and palm print data and said reference fingers and palm print data.

8. The collating method according to claim 7, wherein said collating comprises:
carrying out collating processes of a plurality of said pairs continuously or in parallel.

9. The collating method according to claim 8, further comprising:
assigning a part of a shared memory area as a work area to each of said collating processes.

10. The collating method according to claim 9, further comprising:
assigning fixed memory areas having a same capacity to collation programs in advance.

11. A computer-readable software medium in which codes of a program are written to realize a collating method, wherein said collating method comprises:
providing a pair of a target fingers and palm print data and a reference fingers and palm print data, which have a same data structure, and each of which contains a fingerprint data and a palm print data; and
collating said target fingers and palm print data and said reference fingers and palm print data.

12. The computer-readable software medium according to claim 11, wherein said collating comprises:
carrying out a collating process of a plurality of pairs continuously or in parallel.

13. The computer-readable software medium according to claim 12, wherein said collating method further comprises:
assigning a part of a shared memory area as work areas to said collating processes when a plurality of said collating processes are executed.

14. The computer-readable software medium according to claim 13, wherein said collating method further comprises:
assigning fixed memory areas having a same capacity to collation programs in advance.
